(19) United States
(12) Patent Application Publication
(10) Pub. No.: US 2012/0307069 A1
(43) Pub. Date: Dec. 6, 2012

(54) SURVEILLANCE SYSTEM WITH VIDEO COMPRESSION FOR WIRELESS TRANSMISSION

(76) Inventor: James PIERCE, Cumming, GA (US)

(21) Appl. No.: 13/151,558

(22) Filed: Jun. 2, 2011

(51) Int. Cl. H04N 7/18

(52) U.S. Cl. 348/159; 348/E07.085

(57) ABSTRACT

A digital surveillance system in which the output signal of the camera is highly compressed, to the extent that the compressed signal can be sent over relatively low bandwidth wireless networks, such as cellular networks. The compressed signal is then uploaded to the wireless network from where it can be relayed to a server, such as an internet server, from where it can be accessed, viewed, manipulated and further used by authorized personnel. Such authorized personnel need not be proximate to the surveillance equipment at all. The digital surveillance system can include fixed cameras mounted in fixed orientations and the signals of the various fixed cameras can be integrated into a wide view, as well as used as individual narrow views. These views are wirelessly communicated to an internet server from where they can be accessed, viewed, manipulated and further used by authorized personnel. To power the cameras and the wireless communication device, one or more solar panels are mounted on or applied to the fixed camera mount.

### BACKGROUND OF THE INVENTION

1. Field of the Invention

The present invention relates to the field of digital surveillance cameras. Specifically, the invention relates to a wireless digital surveillance system making use of video compression for communicating the video over wireless networks.

2. Background

Current video surveillance systems can be limited by multiple factors. Typical prior art surveillance cameras are of the pan-tilt-zoom (PTZ) type, which have a limited view of the area on which their lenses are fixed at any given time. Therefore, such prior art surveillance cameras and systems are focused on a small viewing area and do not have any visibility outside of the current viewing area of the camera. In order to view other physical spaces in their surveillance area, an operator must pan, tilt, or zoom the camera remotely or constantly monitor the screens as the cameras automatically move over a specific area. Thieves and other undesirable or unauthorized persons have learned, unfortunately, to time their movements to those moments when the camera is looking the other way. In this regard, the camera system can be defeated by watching and waiting for the camera to pan to a different location, leaving some areas unwatched for a length of time.

Often, in closed-circuit video systems, the individuals monitoring and operating such cameras must be in the same proximate location as the cameras, putting yet another limitation on their use. PTZ cameras lose even more of their field of view when they are zoomed in on a particular area of concern.

Certain non-PTZ cameras, such as “fish-eye” cameras with 360-degree views, may distort the image to the point where the image is not usable to determine any detail. Additionally, surveillance cameras and systems often do not have the availability of a stand-alone, self-sustaining power source. Therefore, if the power fails or is intentionally cut, the surveillance system fails. They are also frequently hard-wired into a closed-circuit system, which can result in failure or loss of signal if part of the system is damaged or vandalized.

In instances where digital cameras are wirelessly linked to a monitoring station, such is typically accomplished by dedicated radio transmission equipment (i.e., the user of the surveillance equipment has to purchase, install, and maintain radio equipment for relaying the video signal from the digital camera to the monitoring station). Such is often beyond the financial or technical reach of many prospective users of video surveillance systems.

### SUMMARY OF THE INVENTION

Generally speaking, the present invention comprises a digital surveillance system in which the output signal of the camera is highly compressed, to the extent that the compressed signal can be sent over relatively low bandwidth wireless networks, such as cellular networks for example. The compressed signal is then uploaded to the wireless network from where it can be relayed to a server, such as an internet server from where it can be accessed, viewed, manipulated and further used by authorized personnel. Such authorized personnel need not be proximate to the surveillance equipment at all.

In a first example embodiment, the present invention comprises a wireless digital surveillance system for monitoring remote locations and includes a camera mount and a camera assembly mounted to the camera mount for outputting a video output. A video processor is provided for collecting the video output of the camera assembly and for compressing the video into a low-bandwidth video signal suitable for transmission over cellular networks. A wireless communication device is provided for wirelessly communicating the low-bandwidth video signal from the video processor over a low bandwidth wireless network (such as a cellular network) and ultimately to a server for access and viewing by a user.

Advantageously, this allows the video surveillance system to be placed in a great many locations not heretofore amenable to surveillance. In this regard, surveillance can be accomplished virtually anywhere one can communicate wirelessly, such as throughout wide areas of cellular coverage. The surveillance system can also be used with a variety of low bandwidth wireless networks, such as satellite, land mobile radio, etc.

The camera assembly can include a plurality of fixed digital cameras fixedly mounted to the camera mount, with individual ones of the fixed digital cameras pointing in different directions from one another. Moreover, the video processor can collect the outputs of the plurality of fixed digital cameras and integrate them into an integrated low-bandwidth video signal having a wide view and multiple narrow views. Preferably, the video processor's low-bandwidth video signal can have a bandwidth of as little as about 6 kbps or so, which makes the signal suitable for a wide range of wireless networks.

Optionally, the video processor monitors available bandwidth over a cellular network and adjusts the bandwidth of the low-bandwidth video signal so as to not exceed the available bandwidth over the low-bandwidth wireless network, such as a cellular network.

In another example form, the invention comprises a digital surveillance system for remote locations without ready access to electric power, and includes a fixed camera mount and a fixed camera assembly mounted to the fixed camera mount, with the camera assembly including plurality of fixed digital cameras fixedly mounted to the fixed camera mount, with individual ones of the fixed digital cameras pointing in different directions from one another. A video processor is provided for collecting the outputs of the plurality of fixed digital cameras, for integrating the outputs of the plurality of fixed digital cameras into an integrated video signal having a wide view and multiple narrow views, and for outputting the integrated video signal. A wireless communication device is provided for communicating the integrated video signal wirelessly to an internet server for access and viewing by a user over the internet. Moreover, a solar power panel is supported upon the fixed camera mount for supplying the camera assembly and the wireless communication device with electric power.

Optionally, the solar power panel can charge a battery, which in turn provides the power to the electronics.

Optionally, the fixed camera mount comprises a free-standing pole mounted to the ground or to another structure. Further, the free-standing pole can include a photovoltaic fabric and a solar panel.

To fool would-be thieves and other unauthorized persons, an oscillating element having the appearance of a panning/tilting camera can be mounted on the fixed camera mount to create a false sense of security in the unauthorized persons.

Preferably, the wide view is created by digitally stitching together multiple narrow views and the wide view and/or the narrow views can be digitally zoomed and panned.

Optionally, a video enhancer can be interposed between the camera system and the wireless communication device. Optionally, a digital video recorder can be mounted within the fixed camera mount.

Optionally, the wireless communication device comprises a wireless modem housed within the fixed camera mount. Alternatively, the wireless communication device can comprise a Bluetooth communication device or a Wi-Fi transmitter. Optionally, these elements could be mounted to the exterior of the camera mount or inside the camera mount.

Another example embodiment of the present invention provides a digital surveillance system that provides a panoramic (for example 180-degree) field of view of a particular area. An embodiment of the present invention includes camera assembly having a plurality of digital cameras arrayed such that the field of view of each is digitally combined to create the optional 180-degree view. Such camera assembly can be placed on a pole that may be secured to the ground or to another structure so that it remains standing even in severe weather. Such a pole can be wrapped in a material capable of providing solar power to the unit, can be powered by a building electrical system, or can have a separate, independent power source, such as a generator. Such an embodiment of the invention can include video manipulation technology that allows a user to focus on a particular area of one camera while still maintaining the 180-degree view of the collective of cameras.

Such an embodiment can also include a wireless transmission system to stream the content from the surveillance cameras to a computer network, such as the Internet, to a monitoring location that can be located anywhere geographically. Therefore, the individual user can monitor the surveillance systems from the other side of a building or the other side of the planet.

Another example embodiment of the invention comprises a digital surveillance system for temporary or portable deployment, including a fixed camera mount comprising an enclosure and a camera assembly including plurality of fixed digital cameras fixedly mounted to the fixed camera mount, with individual ones of the fixed digital cameras pointing in different directions from one another. A video processor is provided for collecting the outputs of the plurality of fixed digital cameras, for integrating the outputs of the plurality of fixed digital cameras into an integrated, compressed video signal having a wide view and multiple narrow views, and for outputting the integrated video signal. The video processor is operable for compressing the video signal to such an extent that the integrated, compressed video signal can be transmitted wirelessly over wireless networks. A wireless communication device is provided for communicating the integrated, compressed video signal wirelessly. A battery is provided for supplying electric power to the camera assembly, the video processor, and the wireless communication device. With this construction, the surveillance system can be temporarily or portably deployed to locations not having electric service handy, can be positioned as desired, and can be operated to send surveillance video signals wirelessly to a remote user monitoring the area under surveillance.

Another example embodiment of the invention is a digital video surveillance system, comprising: a plurality of digital video devices; a structure capable of having said plurality of digital video devices mounted thereon; a video adapter apparatus capable of converting video to digital data; a wireless transmitter capable of communicating with a computer communications network; and a computer in communication with said computer communications network with software stored thereon for converting said digital data to video to be displayed.

### BRIEF DESCRIPTION OF THE DRAWINGS

FIG. 1 is a perspective, schematic view of a surveillance system according to a first example form of the present invention and showing cameras mounted on a solar power pole.

FIG. 1A is an enlarged view of the inset circle portion of FIG. 1, showing photovoltaic cells on the fabric wrapping the surveillance stand structure of an embodiment of the invention.

FIG. 1B is an enlarged view of a portion of FIG. 1, showing a camera system assembly portion of the system of FIG. 1.

FIG. 2 is a perspective, schematic view of the surveillance system of FIG. 1, schematically showing the various components thereof mounted within and on an enclosure.

FIG. 3 is a schematic perspective view of a portion of the enclosure of FIG. 2, showing a door portion thereof open and revealing the mounting of certain components therein.

FIG. 4 is a schematic, functional diagram showing how the surveillance system of FIG. 1 operates to upload the video streams to a server on the internet and to provide access to the same by a user with a computer connected to the internet.

FIGS. 4A and 4B are perspective views of the camera assembly as seen from a front and left side perspective, respectively.

FIG. 5 is a system diagram of an embodiment of the surveillance system of the invention as implemented over a computer network.

FIG. 6 is a perspective, schematic view of the surveillance system of FIG. 1, showing an alternative form of enclosure/mount.

FIG. 7 is a perspective, schematic, partially cut-away view of the surveillance system of FIG. 6.

### DETAILED DESCRIPTION OF EXAMPLE EMBODIMENTS

The present invention may be understood more readily by reference to the following detailed description of certain embodiments of the invention taken in connection with the accompanying drawing figures, which form a part of this disclosure. It is to be understood that this invention is not limited to the specific devices, methods, conditions, or parameters described an/or shown herein, and that the terminology used herein is for the purpose of describing particular embodiments by way of example only and is not intended to be limiting of the claimed invention. All patents and other publications identified in this specification are incorporated by reference as thought fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

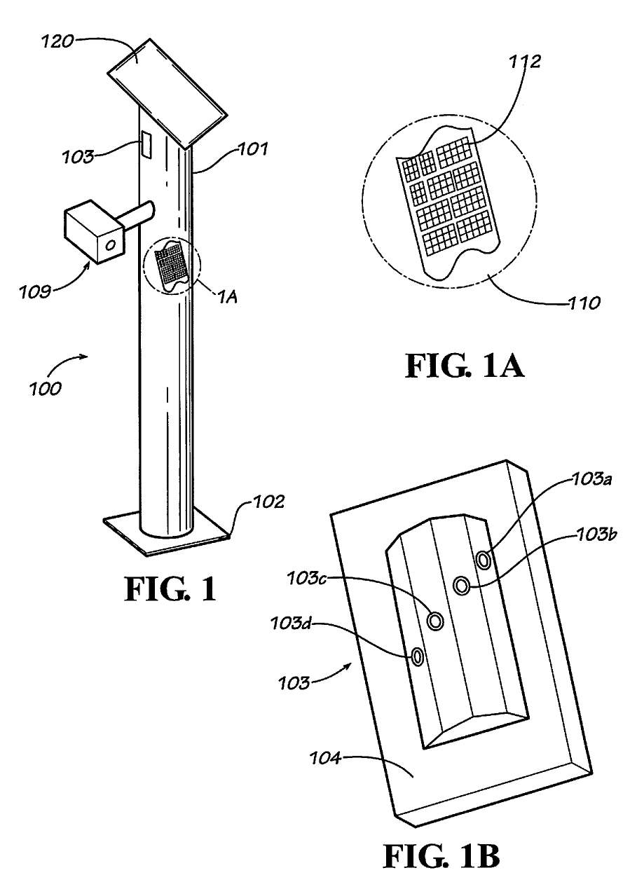

Referring now to the drawings, in which like numerals illustrate like elements throughout the several views, FIG. 1 shows a camera system 100 according to a first preferred form of the invention. The embodiment has a surveillance stand structure 101, a pole in this embodiment. The hollow pole 101 is mounted on a base 102, which may be installed and mounted to the ground, including concrete and other materials, by bolts, stakes, and/or other such means of attachment. The pole is hollow to house and protect various electronic components. A camera assembly 103 is mounted to the surveillance structure 101. In the preferred example embodiment, the camera assembly is a fixed (non-moving) camera system and includes a plurality of individual digital cameras (typically CCD's or CMOS devices). Preferably, the camera assembly 103 has five cameras integrated into a single housing. In the preferred example embodiment, the camera assembly is an “A7-180” model Scallop Imaging camera assembly from Tenebraex Corporation of Boston, Mass. Those skilled in the art will recognize that other camera systems can be employed as well. Such a camera system 103 is a seven megapixel video camera that delivers one 720p HD frame that combines a seamlessly stitched, undistorted 180° view sized to fit within the frame, along with up to four separate detail views from the full 7 megapixel resolution. Such a camera system has an effective field of view of about 180 degrees by 48 degrees, a maximum frame rate of 15 fps, and has an output of 640×480 pixels (NTSC). Thus, the data rate for streaming such video, if not compressed, is about 4.6 megapixels per second (4,600 kps).

The example camera assembly 103 uses a 7 megapixel staring array to produce a 180×48 field of view, non-fisheye, panoramic video. Its staring array has the equivalent resolution (i.e., pixels on target) of 23 standard VGA cameras. The camera system's internal imaging engine presents the user with a 180 degree view plus up to three 8× zoom detail views packaged into one NTSC frame that can be sent over any standard CCTV analog network. Each of the zoom details can be under independent control using standard Pelco-D commands over RS485. Advantageously, the camera is solid state, thus it has no moving parts to fail and require service.

The example camera assembly 103 includes a base enclosure 104 for housing electronics and a faceted, scalloped camera housing 105 which houses multiple video cameras, such as cameras 103a, 103b, 103c, and 103d (see FIG. 1B). Preferably, the camera assembly 103 includes five (5) such cameras, with the distal ones of the cameras pointed oppositely to one another (180 degrees apart), while the central camera 103c is pointed perpendicular thereto. The remaining two intermediate cameras, 103b and 103d, are oriented at 45 degrees relative to the distal cameras (half way between the end cameras and the central camera).

In the exemplary embodiment shown, the cameras are arrayed diagonally, but one of ordinary skill in the art will understand that the individual cameras may be arrayed in any convenient way within the assembly 103. As shown in FIG. 1A, the outer skin of the pole 101 can include a fabric 110 containing photovoltaic cells 112, which can provide solar power to the pole. A solar powered embodiment of the invention such as that described may have batteries charged by the solar cells in order to provide constant power, such as 12VDC, to the electronic components. One of ordinary skill in the art will understand that such batteries will be charged during daylight hours and will be able to hold sufficient charge such that they would provide constant power to the embodiment of the invention during evening and dark hours and cloudy and rainy days.

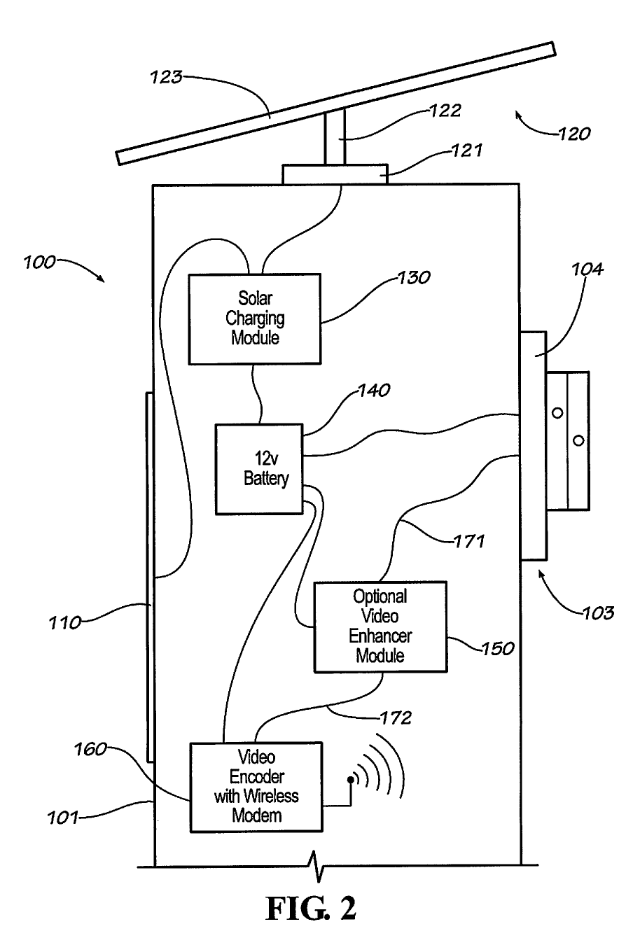

As shown schematically in FIG. 2, the camera system 100 includes a mount or support pole 101, camera assembly 103, and solar power fabric 110. A second solar power source, here a solar panel assembly 120, is mounted atop the pole 101 and is coupled electrically with the solar fabric 110 to a solar power charging module 130. The solar power panel assembly 120 includes a base 121 secured to the pole 101, a pedestal 122 extending from the base 121, and a solar panel 123 secured upon the pedestal 122. The solar charging module 130 is electrically coupled to and charges a 12v DC battery 140 and the battery in turn provides electric power to the other electronic systems. Indeed, the batter 140 provides electric power to the camera system 103, to an optional video enhancer module 150, and to a video encoder 160 (with built-in wireless modem).

Moreover, the video output from the camera system 103 is provided through cabling 171 to the optional video enhancer module 150 and then on to the video encoder (with a wireless modem) 160 via cabling 172. Alternatively, the optional video enhancer module can be omitted and the video output from the camera system can be cabled directly to the video encoder/wireless modem 160.

The output signal of the camera 103 is highly compressed by the video encoder (video processor) 160, to the extent that the compressed signal can be sent over relatively low bandwidth wireless networks, like cellular telephone networks. The compressed signal is then uploaded to the wireless network from where it can be relayed to a server, such as an internet server from where it can be accessed, viewed, manipulated and further used by authorized personnel. Such authorized personnel need not be proximate to the surveillance equipment at all.

Preferably, the video processor 160 collects the outputs of the plurality of fixed digital cameras and integrates the outputs of the plurality of fixed digital cameras into an integrated low-bandwidth video signal having a wide view and multiple narrow views. Preferably, the video processor's low-bandwidth video signal has a bandwidth of about 6 kbps or more, which is low enough to be accommodated on cellular networks. Optionally, the video processor 160 dynamically monitors available bandwidth over the cellular network and adjusts the bandwidth of the low-bandwidth video signal so as to not exceed the available bandwidth over the cellular network that is then available.

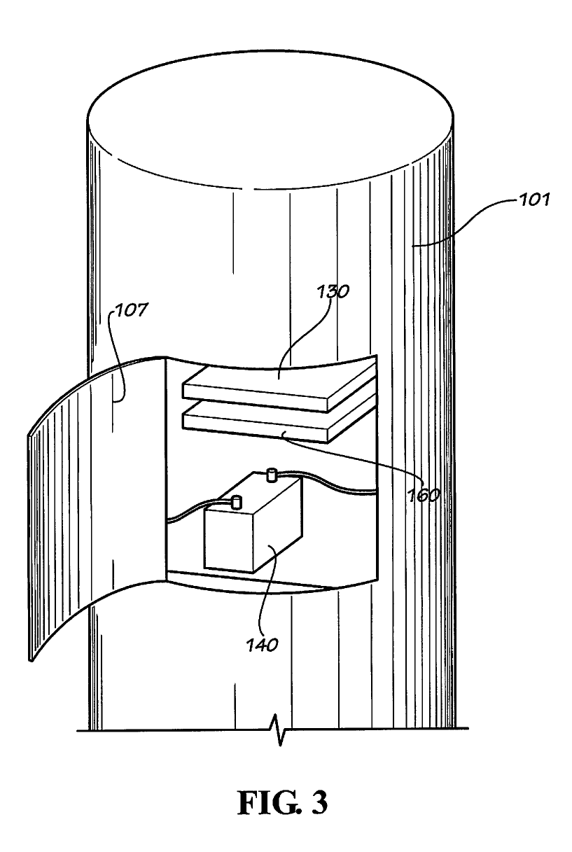

As shown in FIG. 3, the electronics components can be housed within the pole 101. For example, the battery 140 can be mounted in a rack, as well as the video encoder 160 and the solar charging module 130. Such electronic hardware may include a video compression card or other graphics apparatus to convert the video from the camera assembly 103 to data to be transmitted over a computer communications network or a video enhancement card to create a higher resolution video. The hardware may also include a wireless, cellular modem or other wireless transmission device that may use a Bluetooth or Wi-Fi protocol with which to communicate with a computer communications network. Such hardware may also include multiple batteries and a transformer such that the batteries may be charged by solar cells on the outside of the structure. Moreover, in those circumstances where a ready source of 120VAC is available, a connection can be provided to a building electric service or other electrical source. A digital video recorder may also be included as hardware located at the surveillance structure, or it may be located on the premises with the monitoring station, which is discussed below. It will be understood by one of ordinary skill in the art that all equipment may be sized such that it may be located within various sizes and shapes of mounting structures (such as the cylindrical pole depicted, for example) that can vary in both size and shape.

As shown in FIG. 3, the hollow pole 101 can be provided with a movable door 107 for providing selective access to the interior of the pole, such as for servicing or replacing the battery, solar power charging module, video electronics, etc. Referring again to FIG. 1, the fixed camera system 100 can incorporate a fake/dummy pan/tilt/zoom camera 109 on the pole 101 to make unauthorized persons think they can defeat the surveillance camera by timing their movements to the movements of the dummy camera. Thus, if they see the oscillating dummy camera, such unauthorized persons might not think they need to disable the system in some way to avoid detection (believing that timing alone will be sufficient), which would tend to protect the real camera system 103 from damage. Alternatively, such a fake/dummy pan/tilt/zoom camera 109 can be mounted separately from the pole 101 so as to not draw attention to the actual location of the camera 103.

One preferred form of the video encoder 160 is a combined video encoder with built-in wireless modem. Such a unit is presently available from Essential Viewing of Rexford, N.Y. and known as the model TVI C300. The TVI C300 video encoder is a small, low-power unit which allows one to view high quality real-time video, despite low bandwidth. Using the built-in wireless modem, the image quality is relatively high. The video encoder's wireless modem provides access to various commercially available cellular networks, including GPRS, 3G, HSDPA, EDGE and CDMA. It also can communicate via satellite phone, IP radios, the Internet using ADSL, etc. The unit also benefits from a low power requirement of less than 6 watts (0.1 watt when on standby), which can be helpful when relying on battery power or solar power. In addition, the video encoder supports two way audio transmissions to enhance the surveillance capabilities of the system.

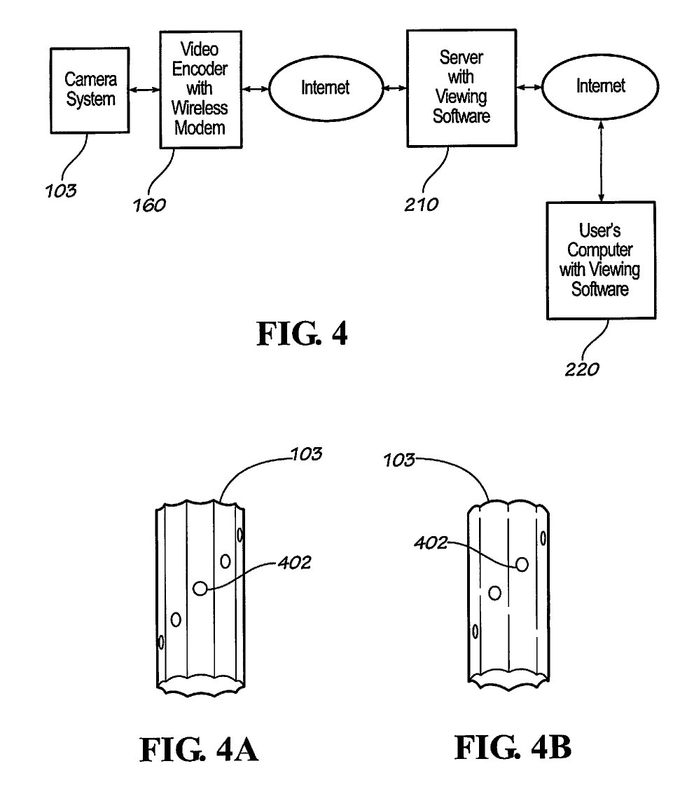

FIG. 4 is a schematic, functional diagram showing how the surveillance system of FIG. 1 operates to upload the video streams to a server on the internet and to provide access to the same by a user with a computer connected to the internet. As shown in this figure, the camera system 103 is coupled to the video encoder/wireless modem 160. The wireless modem 160 uploads the video to an internet-based server 210 where software manages, stores, and makes the video available to authorized users. The authorized users can access the internet-based server 210 by accessing the internet with a computer 220 loaded with appropriate viewing software. Optionally, a video enhancer module can be interposed between the camera system 103 and the video encoder/wireless modem 160. Optionally, a video enhancer module can be interposed between the video encoder/wireless modem 160 and the internet. Alternatively, a video enhancer module can be interposed between the internet-based server 210 and the user computer 220. The communication from the wireless modem 160 to the internet can be accomplished with a 2G or 3G air card. The communication from the internet to the server typically is facilitated with a T1 or T3 line. The communication from the user computer 220 to the internet can be accomplished by any number of known technologies.

FIGS. 4A and 4B are views of the camera assembly 103 of an embodiment of the invention from a front and left side view, respectively. Five of the cameras are included in the assembly 103 in the exemplary embodiment of the invention. Such an assembly 103 contains openings 402 providing each camera a different view of the 180-degree arc view of the system. Although in the renderings of FIGS. 4A and 4B the camera openings 402 are arranged diagonally across the 180-degree sweep of the embodiment of the invention, one of ordinary skill in the art will understand that any arrangement of cameras and openings is acceptable so long as an entire 180-degree span of view is accommodated by a camera assembly 103. A camera used in an example embodiment of the invention is a 1.3 Megapixel CMOS camera device, such as that used in a cellular telephone camera or web camera. Such a camera 103 may have 6,553,600 effective pixels, include an electronic rolling shutter, automatic gain control, a depth of field of 2 feet to infinity, require 0.5 lux minimum illumination, and capable of up to 8× zoom.

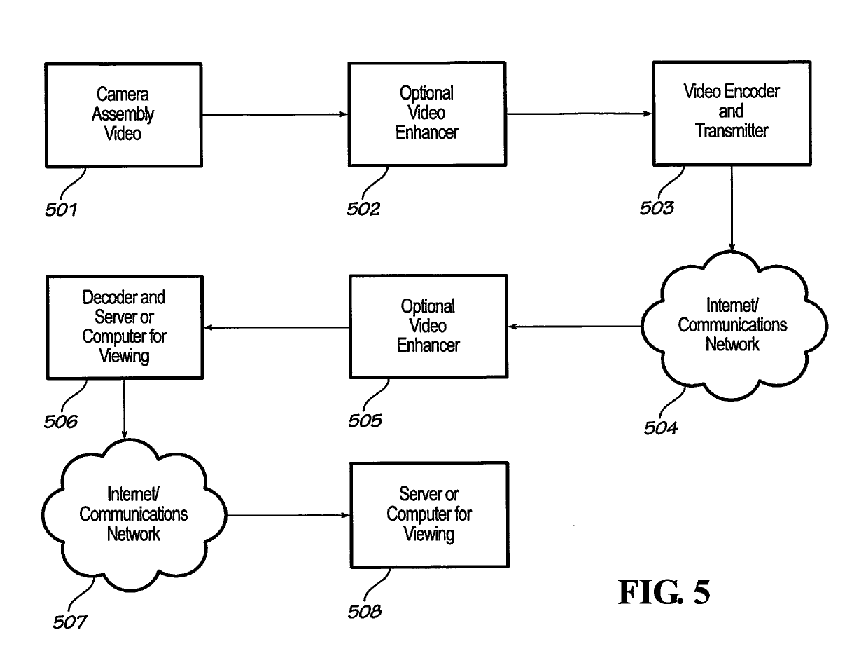

FIG. 5 is a logical rendering of the system of the invention. At 501, the camera assembly 103 records video of the surveillance area. An alternate embodiment of the system of the invention may contain a video enhancer 502, which augments and enhances the video from the camera to provide a better view to the operator/monitor. At 503, the video is then compressed to the extent that the compressed signal can be sent over relatively low bandwidth wireless networks, like cellular telephone networks. The video encoder also encodes the signals such that the video from the multiple camera sources mounted within the assembly 103 are stitched together to form a panoramic, 180-degree view of the surveillance area. An embodiment of the invention may include with the encoder, or as a separate piece of equipment 301, a transmitter such as a wireless cellular modem, and Bluetooth transmitter, or a device capable of connecting to a Wi-Fi hotspot. It will be understood by one of ordinary skill in the art that the transmitter and receiver may be configured in any way desirable so long as video data may streamed via the connection. The connection may also be a wired broadband, fiber optic, Ethernet, or other data network connection. The video is then transmitted via a computer network 504, such as the Internet, or any other digital data and computer-based communications network capable of transmitting video data.

At the data receiver, which is connected to the computer network 504 by any functional communications link, either a T1/T3 or other broadband communications line, or via wireless communications network as discussed above, another signal or video enhancer 505 may be placed to augment the signal and data received. One of ordinary skill in the art will understand that the enhancer, receiver, and decoder 506 may be configured as desired to achieve the necessary results. The decoder 506 includes software, which may be located on a server or a stand-alone computer, either or both of which are capable of being connected to the computer communications network 504, that is capable of converting the received data back to video and reconstructing the 180-degree panoramic view. Also included on the server or stand-alone computer 506 is software capable of viewing the video stream. Another capability of the system is such that a plurality of the individual camera views may be shown with the panoramic view, and the software can provide zoom capability for any individual camera views.

At 507 and 508, after being decoded, the video may be transmitted via additional computer network to additional monitoring stations. Such flexibility for monitoring locations and reducing the video feed to a matter of standard data transmission allows the surveillance video to be monitored by various operators located anywhere geographically and needing little more than the appropriate software.

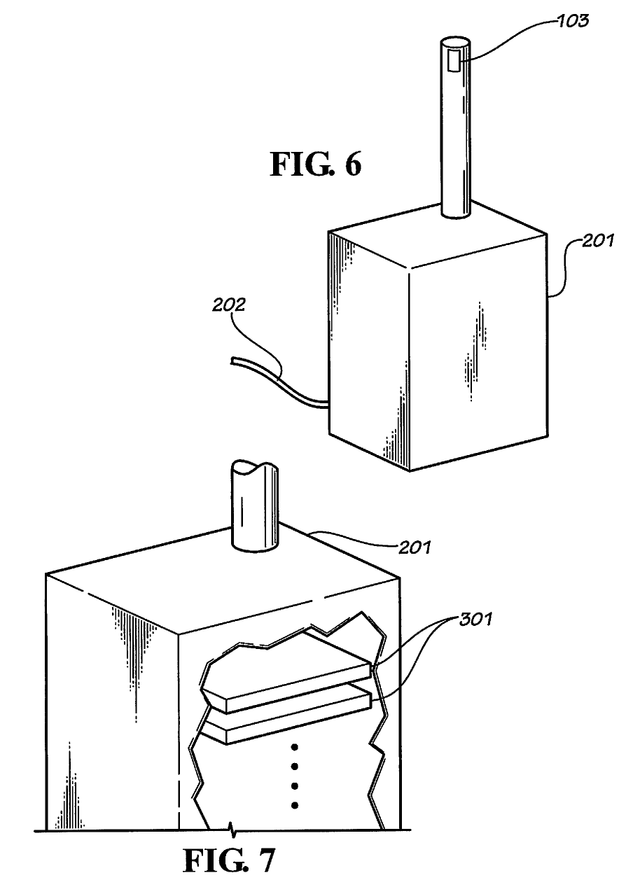

One of ordinary skill in the art will also appreciate that the camera assembly 103 may be mounted on a variety of structures 201, such as that shown in FIGS. 6, 7. Such an alternative structure 201 may be of varying shape, size, and height desired and necessary to view the area of interest. One of ordinary skill in the art will also understand and appreciate that a surveillance stand structure 101 or other alternative structure 201 that may be selected on which to mount the video cameras 103 may also be powered by connecting the structure 201 to a building power source, such as a 110/220V power source, via a power cable 202. One of ordinary skill in the art will also understand that the voltages and power source for the embodiment of the invention may also be adapted for voltage usage compatible with other, international voltage systems.

The present invention has numerous applications. One ready application is the use of surveillance cameras at remote locations not serviced by electric power and/or not readily amenable to connecting the cameras by electric cabling. For instance, public parks (which often don't have power outlets or computers systems on-site) can be monitored using such a system by providing a solar-powered pole with a camera system having a high-performance video encoder for uploading highly compressed camera video signals to a locally available cellular network. The invention also allows small police forces to monitor various remote locations, without requiring the police forces to obtain, install, maintain and utilize dedicated radio equipment for linking the various camera installations with a monitoring station. Similarly, businesses and other organizations can likewise monitor and manage far-flung sites, without a large investment in infrastructure. Moreover, police forces and others can temporarily or portably monitor specific locations on an ad hoc basis by locating a self-contained enclosure at the location to be monitored and then viewing the video remotely, without running wires or electric service to the camera system. Those skilled in the art will readily appreciate that many more such applications exist.

It will be apparent to those skilled in the art that many modifications and variations may be made to embodiments of the present invention, as set forth above, without departing substantially from the principles of the present invention. All such modifications and variations are intended to be included herein within the scope of the present invention, as defined in the claims that follow.

I claim:

1. A wireless digital surveillance system for monitoring remote locations, the surveillance system comprising:
a camera mount;
a camera assembly mounted to the camera mount for outputting a video output,
a video processor for collecting the video output of the camera assembly and for compressing the video into a low-bandwidth video signal suitable for transmission over low bandwidth wireless networks; and
a wireless communication device for wirelessly communicating the low-bandwidth video signal from the video processor over a low bandwidth wireless network and ultimately to a server for access and viewing by a user.

2. The digital video surveillance system of claim 1, wherein the camera assembly comprises a plurality of fixed digital cameras fixedly mounted to the camera mount, with individual ones of the fixed digital cameras pointing in different directions from one another, and wherein the video processor collects the outputs of the plurality of fixed digital cameras and integrates the outputs of the plurality of fixed digital cameras into an integrated low-bandwidth video signal having a wide view and multiple narrow views.

3. The digital video surveillance system of claim 1, wherein the wireless communication device comprises an air card.

4. The digital video surveillance system of claim 1, wherein video processor's low-bandwidth video signal has a bandwidth of about 6 kbps or more.

5. The digital video surveillance system of claim 1, further comprising a battery operably coupled to a solar power panel affixed to the camera mount.

6. The digital video surveillance system of claim 1, further comprising a 12v battery positioned within the camera mount for powering the camera assembly, the video processor, and the wireless communication device.

7. The digital surveillance system of claim 1, wherein the camera mount comprises a free-standing pole mounted to the ground or to another structure.

8. The digital surveillance system of claim 7, wherein said free-standing pole includes a photovoltaic fabric and wherein the free-standing pole has a solar panel thereon.

9. The digital surveillance system of claim 1, further comprising an oscillating element having the appearance of a panning/tilting camera.

10. The digital surveillance system of claim 2, wherein the wide view is created by digitally stitching together multiple narrow views.

11. The digital surveillance system of claim 2, wherein the wide view and/or the narrow views can be digitally zoomed and panned.

12. The digital surveillance system of claim 1, further comprising a video enhancer for enhancing the resolution, contrast, or low-light sensitivity of the video.

13. The digital surveillance system of claim 12, wherein the video enhancer is interposed between the camera and the wireless communication device.

14. The digital surveillance system of claim 1, wherein the low bandwidth wireless network is a cellular wireless network.

15. The digital surveillance system of claim 1, wherein the wireless communication device comprises a wireless modem housed within the camera mount.

16. The digital surveillance system of claim 1, wherein the wireless communication device comprises a Bluetooth communication device housed within the camera mount.

17. The digital surveillance system of claim 1, wherein the wireless communication device comprises a Wi-Fi transmitter housed within the camera mount.

18. The digital surveillance system of claim 1, wherein the camera assembly comprises at least three cameras peering in different directions.

19. The digital surveillance system of claim 1, wherein the camera assembly comprises at least five cameras peering in different directions.

20. The digital surveillance system of claim 1, wherein the camera assembly comprises a single camera peering in a fixed direction and being controlled to zoom in and out on demand.

21. The digital surveillance system of claim 1, wherein the camera mount comprises a portable or temporary structure.

22. The digital surveillance system of claim 1, wherein the server is an internet-based server and the user accesses the server via the internet.

23. The digital surveillance system of claim 1, wherein the video processor monitors available bandwidth over the low-bandwidth wireless network and adjusts the bandwidth of the low-bandwidth video signal so as to not exceed the available bandwidth over the low-bandwidth wireless network.

24. The digital surveillance system of claim 1, further comprising a video analytics module adjacent the camera assembly for monitoring the output for certain activities and sending an alarm signal in response to detecting the activity or activities.

25. The digital surveillance system of claim 1, further comprising a video analytics module at the server for monitoring the output for certain activities and sending an alarm signal to one or more users/locations in response to detecting the activity or activities.

26. A digital surveillance system for remote locations without ready access to electric power, the system comprising:
a fixed camera mount;
a camera assembly including plurality of fixed digital cameras fixedly mounted to the fixed camera mount, with individual ones of the fixed digital cameras pointing in different directions from one another;
a video processor for collecting the outputs of the plurality of fixed digital cameras, for integrating the outputs of the plurality of fixed digital cameras into an integrated, compressed video signal having a wide view and multiple narrow views, and for outputting the integrated video signal, the video processor being operable for compressing the video signal to such an extent that the integrated, compressed video signal can be transmitted wirelessly over low-bandwidth wireless networks;
a wireless communication device for communicating the integrated, compressed video signal wirelessly over a low-bandwidth wireless network and for relaying the same on to an internet server for access and viewing by a user over the internet; and
a solar power panel supported upon the fixed camera mount for supplying electric power.

27. The digital video surveillance system of claim 26, wherein said solar panel comprises photovoltaic fabric.

28. The digital video surveillance system of claim 26, further comprising a battery operably coupled to the solar power panel.

29. The digital surveillance system of claim 28, wherein said battery is charged by photovoltaic cells.

30. The digital surveillance system of claim 26, wherein said fixed camera mount comprises a free-standing pole mounted to the ground or to another structure.

31. The digital surveillance system of claim 30, wherein said free-standing pole includes a photovoltaic fabric and wherein the free-standing pole has a solar panel thereon.

32. The digital surveillance system of claim 31, further comprising an oscillating element having the appearance of a panning/tilting camera.

33. The digital surveillance system of claim 26, wherein the wide view is created by digitally stitching together multiple narrow views.

34. The digital surveillance system of claim 26, wherein the wide view and/or the narrow views can be digitally zoomed and panned.

35. The digital surveillance system of claim 26, further comprising a video enhancer interposed between the camera system and the wireless communication device.

36. The digital surveillance system of claim 26, wherein the wireless communication device comprises a Bluetooth communication device housed within the fixed camera mount.

37. The digital surveillance system of claim 26, wherein the wireless communication device comprises a Wi-Fi transmitter housed within the fixed camera mount.

38. The digital surveillance system of claim 26, wherein said camera assembly comprises a camera housing and multiple cameras peering in different directions.

39. A digital surveillance system for temporary or portable deployment, the system comprising:
a fixed camera mount comprising an enclosure;
a camera assembly including plurality of fixed digital cameras fixedly mounted to the fixed camera mount, with individual ones of the fixed digital cameras pointing in different directions from one another;
a video processor for collecting the outputs of the plurality of fixed digital cameras, for integrating the outputs of the plurality of fixed digital cameras into an integrated, compressed video signal having a wide view and multiple narrow views, and for outputting the integrated video signal, the video processor being operable for compressing the video signal to such an extent that the integrated, compressed video signal can be transmitted wirelessly over wireless networks;
a wireless communication device for communicating the integrated, compressed video signal wirelessly; and
a battery for supplying electric power to the camera assembly, the video processor, and the wireless communication device;
whereupon the surveillance system can be temporarily or portably deployed to locations not having electric service handy, can be positioned as desired, and operated to send surveillance video signals wirelessly to a remote user monitoring the area under surveillance.
